(19) United States
(12) Patent Application Publication
(10) Pub. No.: US 2025/0171213 A1
(43) Pub. Date: May 29, 2025

(54) Embossed Plastic Strap and Method of Manufacture

(71) Applicant: Signode Industrial Group LLC, Tampa, FL (US)

(72) Inventors: Jonathan Mubarak Ali Moghal, Oxfordshire (GB); Mark James Greenfield, Oxfordshire (GB); Gaurav Maheshkumar Vyas, Oxfordshire (GB); Darren Gary Clayton, Swindon (GB); Guido Leine, Best (NL)

(21) Appl. No.: 18/840,898

(22) PCT Filed: Jul. 26, 2023
(86) PCT No.: PCT/US2023/028751

§ 371 Date: Aug. 22, 2024

Related U.S. Application Data
(60) Provisional application No. 63/393,797, filed on Jul. 29, 2022.

(51) Int. Cl. B65D 63/10; B29C 48/00; B29C 48/08; B29K 23/00; B29L 31/00

(52) U.S. Cl. CPC B65D 63/10; B29C 48/002; B29C 48/022; B29C 48/08; B29K 2023/12; B29K 2995/0077; B29K 2995/0082; B29L 2031/7276

(57) ABSTRACT

Various embodiments of the present disclosure provide a plastic strap and a method of forming a plastic strap. The plastic strap includes a first side extending across a width of the strap, a second side opposite the first side and extending across the width of the strap, and a thickness extending between the first and second sides. The first side is embossed and includes a base surface and a raised pattern extending from the base surface. The raised pattern defines multiple cells. A first one of the cells is defined by a first perimeter component of the raised pattern and a first geometric component positioned within the first perimeter component so part of the base surface extends between the first perimeter component and the first geometric component.

### PRIORITY

This application claims priority to and the benefit of U.S. Provisional Patent Application No. 63/393,797, filed Jul. 29, 2022, the entire contents of which is incorporated herein by reference.

### FIELD

The present disclosure relates to strap used to secure articles for storage or transport, and more particularly relates to embossed strap.

### BACKGROUND

Strapping has long been used to secure the packaging of boxes, pallets loaded with bricks and other objects, large textile bales, and other products. Common materials used for the strapping include steel; polyester, polypropylene, and other plastic materials; and kraft paper. Various materials have different advantages associated with cost, strength, weight, and flexibility. For example, metal strap is strong but typically more expensive than plastic and paper strap. Polypropylene strap is typically less expensive than metal strap, but may stretch longitudinally and loosen when under high tension. Polyester strap is typically less expensive than metal strap, is very strong, and is not easily stretched. Paper strap is typically the cheapest of the different types of strap and repulpable, but is also the weakest.

### SUMMARY

Various embodiments of the present disclosure provide embossed plastic strap and a method of making embossed plastic strap. The embossed plastic strap has a raised pattern including a perimeter component and a geometric shape positioned within the perimeter component. The embossed plastic strap of the present disclosure has improved mechanical properties compared to other embossed plastic strap having different raised patterns.

In one embodiment, plastic strap comprises a first side extending across a width of the strap, a second side opposite the first side and extending across the width of the strap, and a thickness extending between the first and second sides. The first side is embossed and includes a base surface and a raised pattern extending from the base surface. The raised pattern defines multiple cells. A first one of the cells is defined by a first perimeter component of the raised pattern and a first geometric component positioned within the first perimeter component so part of the base surface extends between the first perimeter component and the first geometric component.

In one embodiment, a method of forming a plastic strap comprises extruding a polymer material to form a strap comprising a first side extending across a width of the strap, and a second side opposite the first side and extending across the width of the strap, and a thickness extending between the first and second sides. The first side of the strap is embossed to form a base surface and a raised pattern extending from the base surface. The raised pattern defines multiple cells. A first one of the cells is defined by a first perimeter component of the raised pattern and a first geometric component positioned within the first perimeter component so part of the base surface extends between the first perimeter component and the first geometric component.

### BRIEF DESCRIPTION OF THE FIGURES

FIG. 1 is a schematic side view of one example embodiment of a process for making embossed strap in accordance with the present disclosure.

FIG. 2 is a perspective view of one example embodiment of an embossed strap according to the present disclosure.

FIG. 3 is a schematic cross sectional view of a portion of the embossed strap of FIG. 2.

FIG. 4 is a top elevational view of a portion of the embossed strap of FIG. 2.

FIG. 5 is a top elevational view of the portion of FIG. 4 with components of a raised pattern of a first side of the strap identified.

FIG. 6 is a top elevational view of the portion of FIG. 4 with another aspect of the raised pattern of the first side of the strap identified.

FIG. 7 is a top elevational view of a portion a strap with a raised pattern according to another embodiment of the disclosure.

FIG. 8 is a top elevational view of a portion a strap with a raised pattern according to another embodiment of the disclosure.

FIG. 9 is a top elevational view of a portion a strap with a raised pattern according to another embodiment of the disclosure.

FIG. 10 is a top elevational view of a portion a strap with a raised pattern according to another embodiment of the disclosure.

FIG. 11 is a top elevational view of a portion a strap with a raised pattern according to another embodiment of the disclosure.

FIG. 12 is a top elevational view of a portion a strap with a raised pattern according to another embodiment of the disclosure.

FIG. 13 is a top elevational view of a portion a strap with a raised pattern according to another embodiment of the disclosure.

FIG. 14 is a top elevational view of a portion a strap with a raised pattern according to another embodiment of the disclosure.

FIG. 15 is a top elevational view of a portion a strap with a raised pattern according to another embodiment of the disclosure.

FIG. 16 is an image of a portion of a strap with a raised pattern according to another embodiment of the disclosure.

FIG. 17 is an image of a portion of a strap with a raised pattern.

FIG. 18 is a perspective view of a strap with a raised pattern according to another embodiment of the disclosure modeled in FEA.

FIG. 19 is a perspective view of a strap with a raised pattern modeled in FEA.

FIG. 20 is a perspective view of a strap with a raised pattern modeled in FEA.

FIG. 21 is a perspective view of an embossed strap according to another embodiment of the disclosure modeled in FEA.

FIG. 22 is a perspective view of an embossed strap according to another embodiment disclosure modeled in FEA.

### DETAILED DESCRIPTION

Various embodiments of the present disclosure provide embossed plastic strap and methods of making embossed plastic strap. As shown in the examples below, a plastic strap that has a raised pattern including a perimeter component and a geometric shape positioned within the perimeter component, as described herein, provides increased strength and improved bending stiffness of the strap compared to other straps. The embossed plastic strap with such a raised pattern can therefore perform at least as well as—and in many cases better than—other embossed strap when used to bundle, unitize, or otherwise secure products. In some embodiments, the embossed plastic strap of the present disclosure is thinner than other embossed strap while still meeting or exceeding specifications for strength and/or stiffness. The embossed plastic strap of the present disclosure can therefore perform the same as other straps while using less strap material, which reduces the cost of the strap.

### I. EMBOSSED PLASTIC STRAP

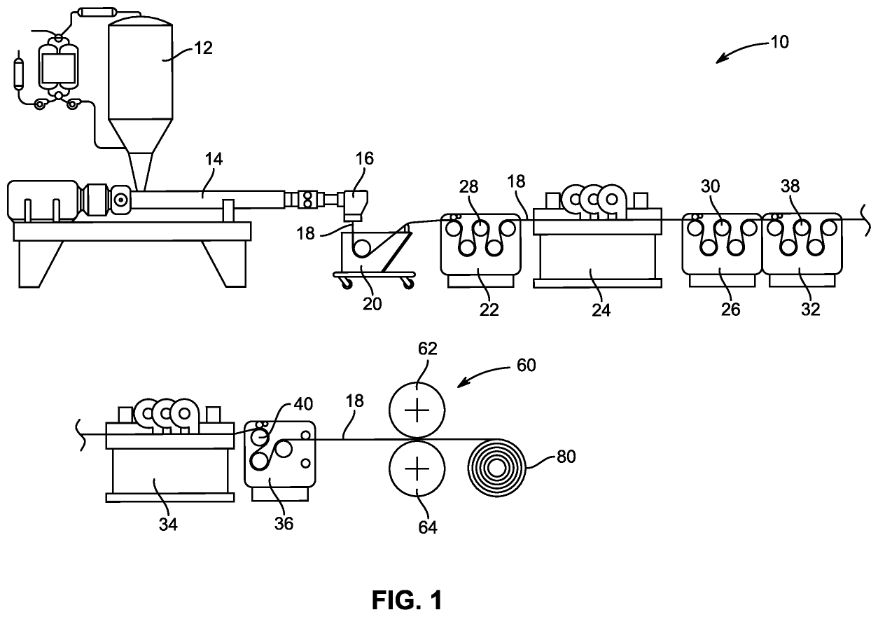

FIG. 1 schematically illustrates a process 10 for manufacturing plastic strap according to one example embodiment of the present disclosure. Raw material (such as polyester or polypropylene flake or pellets) is fed into an extruder feed throat system 12, which feeds the raw material into an extruder 14.

The extruder 14 melts the raw material and mixes them together. The extruder 14 may be a single screw or twin screw extruder, configured for the melting, mixing and conveying of the raw material.

The extruder 14 conveys the melted raw material to a die 16, where the melted raw material is extruded in the form of a strand 18 into a water bath 20. In alternative embodiments, the die 16 may be replaced with a plurality of dies, arranged in parallel, with each die 16 extruding one or more strands 18 into the water bath 20. The strand or strands 18 are typically rectangular in shape, corresponding to the shape of rectangular slot openings present in the face of the die. The water bath 20 is used to rapidly quench the strand to minimize crystallization.

After being quenched, each strand 18 enters and passes through a first roller assembly 22, an oven 24, and a second roller assembly 26, which are collectively used for longitudinally orienting the strand 18. The first roller assembly 22 includes a plurality of nip rollers 28, at least some of which are heated. The nip rollers 28 turn at a first surface velocity, with each roller turning in a direction which conveys the strand 18 forward. The strand 18 winds around and between the nip rollers 28, and is preheated before passing through the oven 24, and to the second roller assembly 26. The second roller assembly 26 includes a plurality of nip rollers 30, at least some of which are heated. The nip rollers 30 turn at a second surface velocity which is faster than the first surface velocity of the nip rollers 28, causing longitudinal orientation of each strand 18 through the oven 24 and between the second set of nip rollers 30.

The first nip rollers 28, oven 24, and second nip rollers 30 are set to temperatures which facilitate heating and longitudinal orientation of each strand 18. Each strand 18 is typically longitudinally oriented by stretching to a length which is about 3-7 times its initial, unstretched length, desirably about 4-6 times its initial, unstretched length. Typically, about 80% of the stretching will take place in the oven 24, and about 20% of the stretching will take place in the second nip roller assembly 26. For instance, where it is desired to stretch a strand 18 to five times its initial length, the second nip rollers 30 will be set to turn at a second surface velocity which is five times as fast as the first surface velocity of the first nip rollers 28. The strand 18 will be stretched to about four times its initial, unstretched length in the oven 24, and slightly further, to about five times its initial, unstretched length, after leaving the oven 24.

After leaving the second nip roller assembly 26, each strand 18 is subjected to an annealing process which includes a third nip roller assembly 32, a second oven 34, and a fourth nip roller assembly 36. The third nip roller assembly 32 includes a third set of nip rollers 38, at least some of which are heated, which turn at a third surface velocity which is desirably about the same as the second surface velocity of the second nip rollers 30. The fourth nip roller assembly 36 includes a fourth set of nip rollers 40, which may or may not be heated, and which turn at a fourth surface velocity that is slightly less than the third surface velocity of the third set of nip rollers 38. The fourth surface velocity may be about 90% to less than 100% of the third surface velocity, and can be about 95% of the third surface velocity.

The third nip rollers 38, oven 34 and fourth nip rollers 40 are set to temperatures which facilitate slight longitudinal direction annealing (shrinkage) of each strand 18, for example to about 95% of its previously stretched length.

The strand or strands 18 then travel through an embossing machine 60 in which at least one embossing roller 62 is pressed against a surface of the strand or strands 18. The illustrated embossing machine 60 includes an upper embossing roller 62 and a lower embossing roller 64, each of which include an embossing pattern that embosses the surface of the strand as the strand moves through the embossing rollers. In other embodiments, only one of the rollers is an embossing roller including an embossing pattern. Further still, in some embodiments, the embossing machine includes a single embossing roller, and the strap is pressed between the embossing roller and another surface. The embossed strand is then cooled and wound into a coil 80 for storage and subsequent use.

This is merely one method of manufacturing embossed plastic strap, and any other suitable method of doing so may be employed to manufacture the embossed plastic strap of the present disclosure.

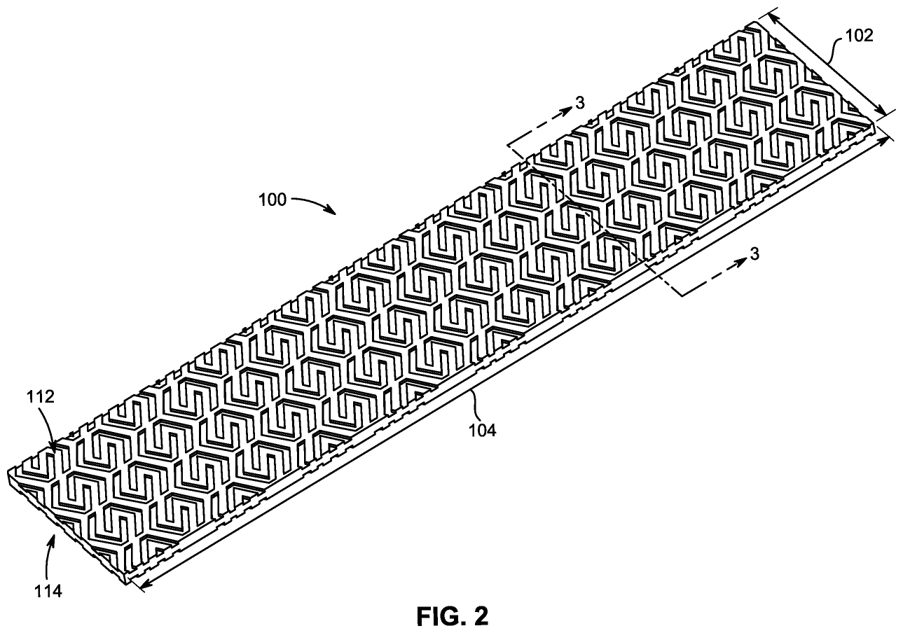

FIG. 2 illustrates a schematic perspective view of one embodiment of embossed plastic strap 100. The strap 100 has a width 102 and extends along a length 104. The length 104 of the strap may vary depending on the use of the strap 100, and may be cut to size for a particular application. The strap 100 includes a first side 112 extending across the width 102 and a second side 114 opposite the first side 110 that also extends across the width 102. Both the first side 112 and the second side 114 of the strap 100 are embossed, as shown with respect to the first side 112 in FIG. 2.

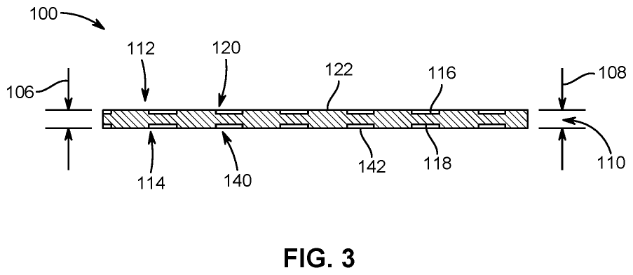

FIG. 3 shows a cross section of a portion of the strap 100. As illustrated, the strap 100 is embossed on both sides such that the first side 112 includes a first raised pattern 120 and the second side 140 includes a second raised pattern 140. Each of the raised patterns 120 and 140 extends outward from a core 110 that spans the width 102 of the strap 100. The core 110 forms a first base surface 116 on the first side 112 of the strap 100 between portions of the first raised pattern 120 and a second base surface 118 on the second side 114 of the strap 100 between portions of the second raised pattern 140.

The strap 100 has a thickness 106 measured from an outer surface 122 of the first raised pattern 120 on the first side 112 of the strap 100 to an outer surface 142 of the second raised pattern 140 on the second side 114 of the strap 100. The strap 100 also has a core thickness 108 measured from the first base surface 116 on the first side 112 of the strap 100 to the second base surface 118 on the second side of the strap 100. In some embodiments, the core thickness 108 is the minimum thickness of the strap 100 between the first side 112 and the second side 114.

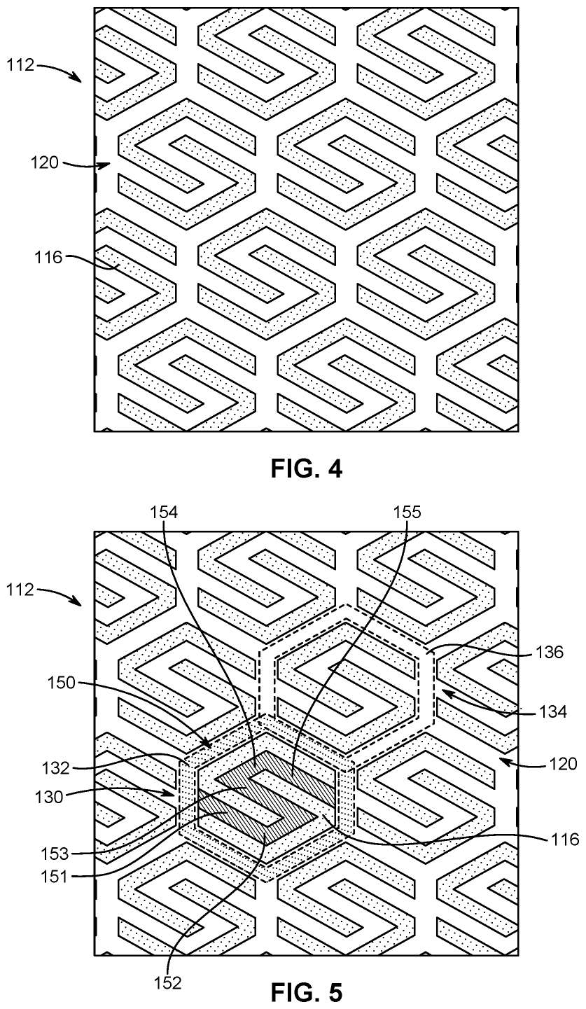

FIG. 4 shows an enlarged view of a section of the first side 112 of the strap 100. In the embodiment of strap 100, shown in FIGS. 2-6, the second side 114 has the same pattern. For clarity, the first raised pattern 120 is shown in white while the first base surface 116 is shaded with a light stippled pattern. The first raised pattern 120 defines multiple cells that extend across the first side 112 along the width 102 and the length 104 of the strap 100, as explained further below.

FIG. 5 illustrates various components of the first raised pattern 120 on the first side 112 of the strap 100. As shown, the first raised pattern 120 includes a first cell 130 defined by a first perimeter component 132 that delineates the boundary of the first cell 130. The first perimeter component 132 is emphasized in FIG. 5 by a dashed line and shading with a medium stippled pattern. The first cell 130 also includes a first geometric component 150 positioned within the first perimeter component 132. For clarity, the first geometric component 150 is shaded with a cross-hatched pattern. As illustrated, part of the first base surface 116 extends between the first perimeter component 132 and the first geometric component 150.

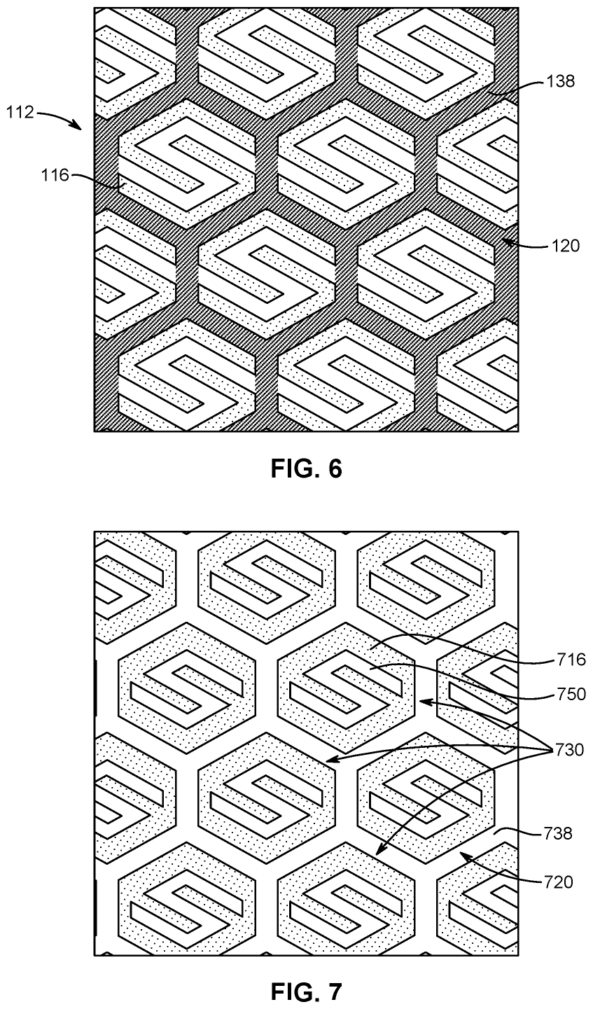

In the illustrated embodiment of strap 100 shown in FIG. 5, the first perimeter component 132 is in the form of a polygon with a hexagonal shape and completely surrounds the first geometric component 150. The hexagonal shape is oriented with opposing straight edges aligned with the length of strap 100. Moreover, the first perimeter component 132 is part of a tessellation that extends across the length and width 102 of the strap 100. The hexagonal tessellation 138 of the first raised pattern 120 of strap 100 is shaded in FIG. 6 with cross hatching for clarity. As shown the tessellation 138 defines the perimeters of the cells of the first raised pattern 120, and each of the cells has the same hexagonal shape. Further, because the cells of the first raised pattern 120 are defined by the tessellation 138, the perimeter components of neighboring cells are shared.

For example, as shown in FIG. 5, the first raised pattern 120 also includes a second cell 134 that is defined by a second perimeter component 136, which is identified in FIG. 5 by additional dashed lines. Similar to the first perimeter component 132, the second perimeter component 136 also has a hexagonal shape that forms a part of the tessellation 138. The first cell 130 is adjacent to the second cell 134 such that one side of the first perimeter component 132 is shared with the second perimeter component 136 so as to form a side of the second perimeter component 136.

The first geometric component 150 of the first cell 130 takes the shape of a non-linear path formed by a plurality of line segments. In particular, the first geometric component 150 has an S-shaped configuration. The term S-shaped refers to a winding path with three sections that are connected by two turns, where the angle of the two turns are in opposite directions. In some embodiments, the turns are at least 90 degrees. For example, the first geometric component 150 of the first cell 130 of strap 100 is formed by a path that includes a first section 151. The path extends around a first turn 152 through an angle of 180 degrees to a second section 153. The path further extends around a second turn 154 through an angle of 180 degrees in the opposite direction to a third section 155.

As shown in FIG. 5, the first geometric component 150 intersects the first perimeter component 132 of the first cell 130. Specifically, opposing ends of the first section 151 and third section 155 of the S-shaped path of the first component 150 intersect opposite sides of the first perimeter component 132. In other embodiments, the geometric component may intersect the perimeter component at a single location, at three or more locations, or at no locations, as explained below.

In various embodiments in which the first raised pattern includes a tessellation, the shape or size of the first geometric component is unique from the shape or size of any portion of the tessellation that defines the cells. For example, the S-shaped configuration of the first geometric component 150 of the first cell 130 is unique from any section of the tessellation 138 of the raised pattern. In other words, in some embodiments, the shape of the first geometric component is different from the shape of the first perimeter component and also different from any subsection of the entire tessellation comprising the respective perimeter components of the cells.

In strap 100, in addition to the first geometric component 150, each of the other cells of the first raised pattern 120 also includes a geometric component disposed within the respective perimeter component. Moreover, the geometric components in each of the cells has the same S-shaped configuration as first geometric component 150. As explained in further detail below, two or more of the cells may have different shapes.

While the first geometric component 150 of first cell 130 of strap 100 intersects the first perimeter component 132 of the first cell 130, in other embodiments, the first geometric component 150 is spaced from the first perimeter component 132 such that the portion of the first base surface 116 within the first cell 130 surrounds the first geometric component 150. For example, FIG. 7 shows an embodiment of an embossed strap surface that includes a raised pattern 720 including a tessellation 738 that forms a plurality of cells 730 that are each delimited by a respective perimeter component in the form of a hexagon. Within each of the cells is a geometric component 750 that has an S-shaped configuration. The size of each geometric component 750 is slightly smaller than the perimeter component of the respective cell 730 such that the base surface 716 within each cell completely surrounds the geometric component.

In some embodiments, a geometric component is included in each of a group of the cells, but not in every cell. For example, FIG. 8 shows an embodiment of a portion of one side of an embossed strap that includes a raised pattern 820 including a tessellation 838 that forms a plurality of cells. The cells include a first group of cells 830, each of which includes a geometric component 850 within the cells 830, and a second group of cells 834 that does not include any geometric component inside the cells 834.

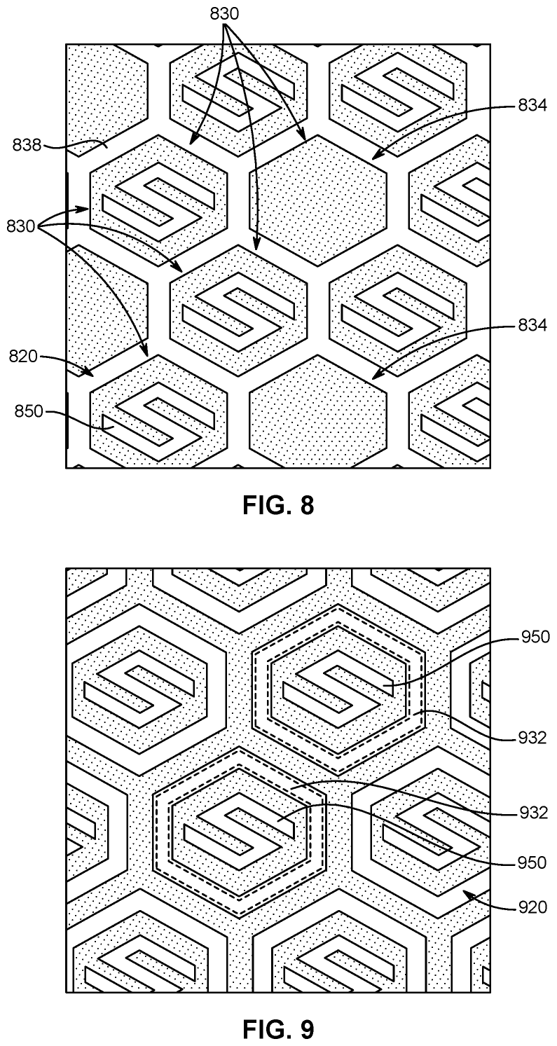

In some embodiments, the cells of the raised pattern are spaced apart such that the perimeter component of one cell is distinct from the perimeter component of a neighboring cell. For example, FIG. 9 shows an embodiment of a portion of one side of an embossed strap that includes a raised pattern 920 with a plurality of individual perimeter components 932 that form separate cells. Geometric components 950 are positioned inside each of the perimeter components 932.

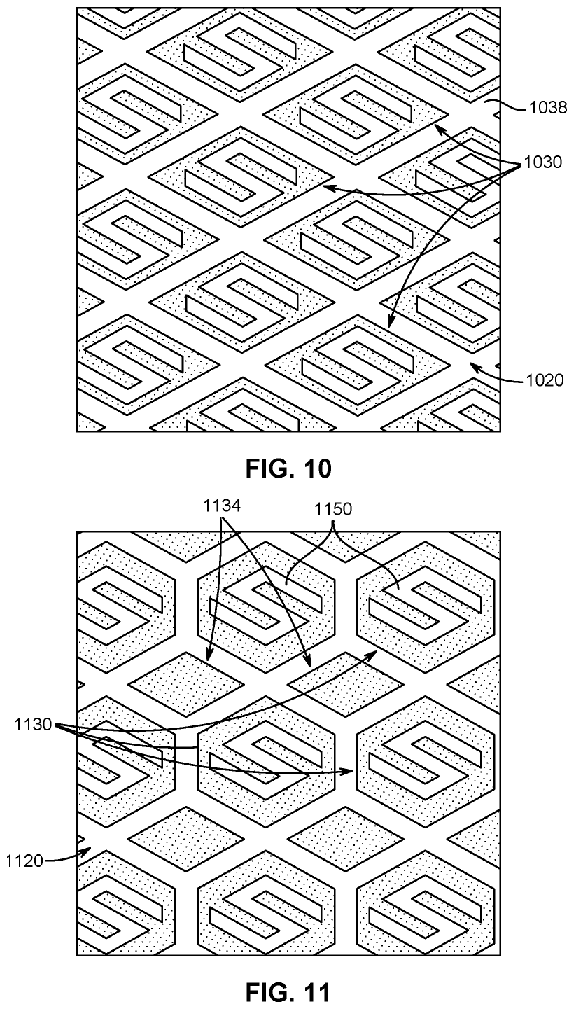

While the tessellation 138 of the first raised pattern 120 of the strap 100 includes a repeating hexagonal shape that forms the perimeter components of the cells, including the first perimeter component 132 and the second perimeter component 136, in other embodiments the raised pattern has cells with other shapes. For example, FIG. 10 shows an embodiment of a portion of one side of an embossed strap that includes a raised pattern 1020 with cells 1030 that have a diamond shape. The perimeter components that define the cells 1030 are formed by a tessellation 1038 of a repeating diamond shape. Further, in some embodiments, the perimeter components may be formed by other shapes, such as squares, triangles, or other polygons. Further still, in some embodiments, the perimeter components may be formed by shapes with curved edges, such as ovals, circles or more complex shapes.

Further, in some embodiments, the cells of the raised pattern are not all the same shape. For example, FIG. 11 shows an embodiment of a portion of embossed strap that includes a raised pattern 1120 with cells of two different shapes. Specifically, the raised pattern includes a tessellation formed by both a hexagonal shape and a diamond shape. Accordingly, the raised pattern includes cells 1130 with a hexagonal shape and cells 1134 with a diamond shape. Although the raised pattern 1120 includes geometric components 1150 only within the hexagonal cells 1130, in other embodiments, the geometric components may be included in the diamond shaped cells, or in both groups of cells.

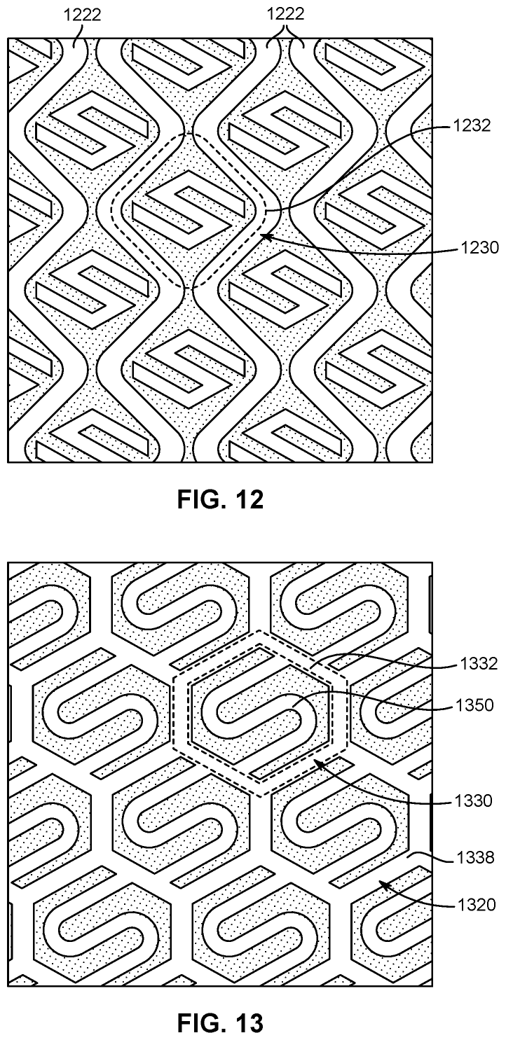

In various other embodiments, the cells of the raised pattern are not defined by a tessellation, and instead are formed by another configuration. For example, in the raised pattern 920 shown in FIG. 9, the cells are formed by individual perimeter components 932. FIG. 12 also shows an embodiment that does not use a tessellation to form the cells. Instead, in the embodiment shown in FIG. 12, a plurality of cells are formed by a series of wavy lines 1222 that come together and separate to form substantially enclosed areas. FIG. 12 illustrates a first cell 1230 that is formed within a first perimeter component 1232 defined by portions of two of the lines 1222.

In the configuration shown in FIG. 12, the first perimeter component 1232 formed by the adjacent lines 1222 does not fully encircle the first geometric component 1250. However, by substantially surrounding the first geometric component 1250, the two lines 1222 form a perimeter component 1232 around the first geometric component 1250. In other embodiments, the first perimeter component extend around at least 95% of the first geometric component, or around at least 90% of the first geometric component, or around at least 80% of the first geometric component.

The first perimeter component 1232 of raised pattern 1220 is also not polygonal, and instead includes curved corners. In other embodiments, the perimeter components of the raised pattern may include other shapes with curved sections, as described above. While the perimeter components of the raised pattern 1220 are not formed by a tessellation, the perimeter components of adjacent cells nonetheless share segments of the raised pattern. In particular, segments of the meandering lines 1222 of the raised pattern 1220 form a portion of the perimeter component of one cell as well as the perimeter component of a neighboring cell.

Although the raised patterns shown in FIGS. 4-12 each include geometric components with the same S-shaped configuration formed from a plurality of straight line segments, other embodiments of the disclosure provide straps with raised patterns that include geometric components of various other shapes. For example, FIGS. 13-15 show such embodiments. In each of the embodiments depicted in FIGS. 13-15 the perimeter components are formed by a hexagonal tessellation. However, in other embodiments of the disclosure, each of the geometric components shown in FIGS. 13-15 is combined with perimeter components that have other configurations, such as those shown in FIGS. 4-12.

FIG. 13 shows an embodiment of a portion of an embossed strap that includes a raised pattern 1320 including a hexagonal tessellation 1338 that forms multiple cells. Within each cell is a geometric component. As illustrated with respect to a first cell 1330, the geometric component 1350 is formed by a non-linear path including both straight and curved sections that forms an S-shaped configuration. Both ends of the path intersect the first perimeter component 1332 that surrounds the geometric component 1350.

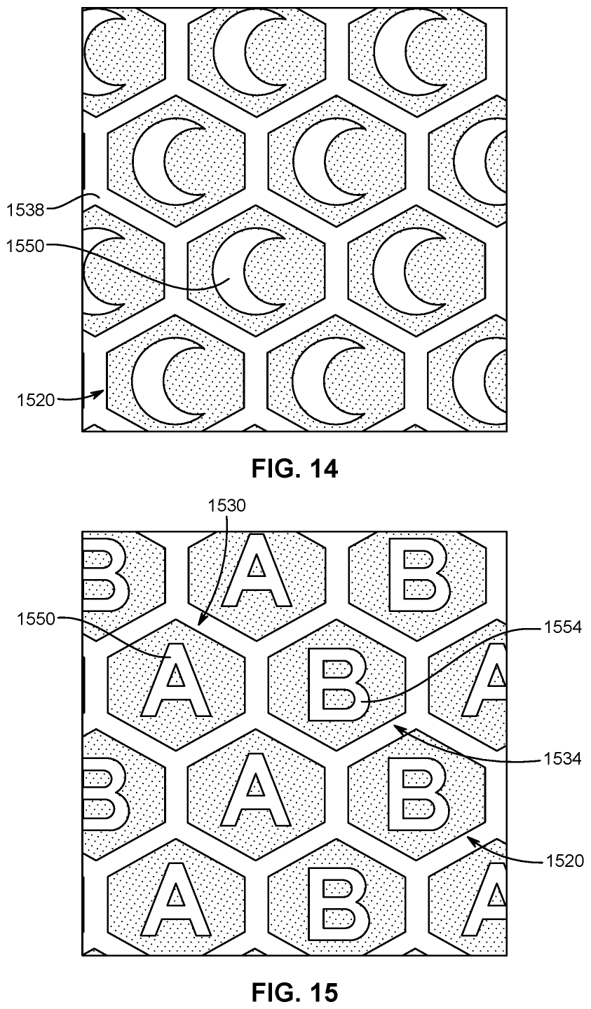

FIG. 14 also shows an embodiment of a portion of an embossed strap that includes a raised pattern 1420 including a hexagonal tessellation 1438 that forms multiple cells. Each of the cells includes a geometric component 1450 in the shape of a crescent moon. In other embodiments, the geometric components may have another shape or may have the shape of a character, such as a letter or number. Further, in some embodiments, the geometric components of different cells may have different shapes. For example, FIG. 15 shows an embodiment of a portion of an embossed strap that includes a raised pattern 1520 that forms a first cell 1530 and a second cell 1534. As shown, the first cell 1530 includes a first geometric component 1550 in the shape of the letter A while the second cell 1534 includes a second geometric component 1554 in the shape of the letter B.

Embodiments of the strap of the disclosure may be formed with various different plastic materials. For example, the plastic material may be selected from polyesters, polyolefins, polyamides or mixtures thereof. In particular, in some embodiments, the strap comprises polyester and/or polypropylene. Further, the strap may also include blends of other polymer materials, as well as additives and/or fillers.

Embodiments of the strap of the disclosure may have various different sizes. In some embodiments, the strap has a width of at least 5 mm, for example, at least 6 mm. Further, in some embodiments, the strap has a width no greater than 25 mm, for example, no greater than 20 mm. As an example, the width of the strap may be about 10 mm. The term about, as used herein, means plus or minus 10%.

Further, in some embodiments, the strap has a thickness of at least 0.40 mm, for example, at least 0.42 mm. Further, in some embodiments, the strap has a thickness no greater than 0.60 mm, for example, no greater than 0.47 mm. As an example, the thickness of the strap may be about 0.43 mm.

### II. EXAMPLES

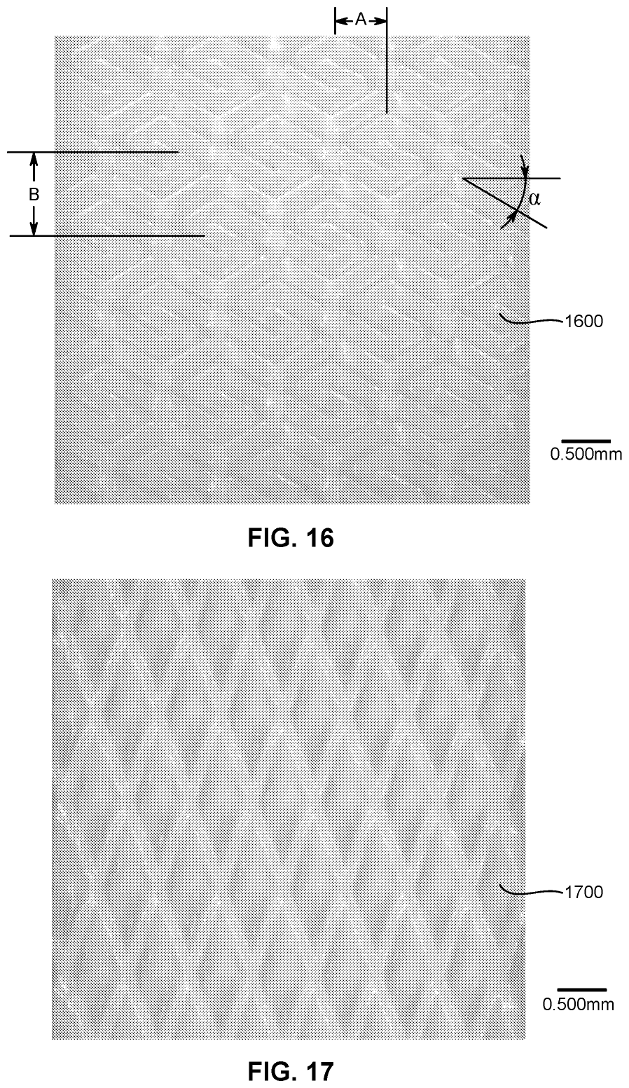

Testing was performed on example embossed plastic strap. FIG. 16 illustrates a portion of an embossed strap 1600 having a raised pattern on opposing sides of the strap. The raised pattern of strap 1600 includes a hexagonal tessellation that forms a perimeter component of multiple cells across both sides of the strap. Within each cell is geometric component having an S-shaped configuration that intersects the respective perimeter component, similar to the embodiment shown in FIGS. 2-6.

FIG. 16 illustrates dimensions of the raised pattern of strap 1600. As shown, the distance between the center points across the width of the strap of neighboring cells in offset rows, indicated by A, is 1.38 mm. Likewise, the distance between the center points along the length of the strap of such cells, indicated by B, is 2.04 mm. Further, the angled side of the hexagon is at an angle with respect to the width direction, indicated by a, of 30 degrees.

Further, FIG. 17 illustrates another embossed strap 1700 having a raised pattern. The raised pattern of strap 1700 is formed by a diamond-shaped tessellation that forms a plurality of cells. None of the cells of the raised pattern of strap 1700 include a geometric component therein.

Tensile testing in line with ASTM D3950-17 was performed on embossed strap 1 and embossed strap 2. The embossed strap 1 is a different specimen of the embossed strap 1600 shown in FIG. 16, and the embossed strap 2 is a different specimen of the embossed strap 1700 shown in FIG. 17.

The embossed strap 1 and embossed strap 2 are made of primarily polypropylene. The embossed strap 1 and embossed strap 2 were made from the same material blend on the same manufacturing line, with the only difference being the embossing rollers and the distance between the embossing rollers. Accordingly, the raised pattern of strap 1 and the raised pattern of strap 2 were embossed on the same strap during the trial. The embossed strap 1 is about 4% less weight than the embossed strap 2 per unit length. The following data were obtained:

TABLE 1
In Table 1, “Crosshead Travel at Break” refers
to total deflection at point of fracture.

| | | | Maximum | Crosshead |
|---|---|---|---|---|
| | | | Strength | Travel |
| | Thickness | Width | at Break | at Break |
| Strap | (mm) | (mm) | (N) | (mm) |
| 1 | 0.47 | 11.70 | 1512 | 10.4 |
| 2 | 0.65 | 11.60 | 1367 | 12.6 |

Compared with the embossed strap 2, the embossed strap 1 has a higher break strength and a lower elongation. Without intending to be bound by theory, the present inventors believe that the raised pattern of the strap 1 provides increased break strength and reduced elongation of the strap. In this regard, the present inventors believe that the perimeter components formed by the hexagonal tessellation increases stiffness of the embossed strap 1 by reducing crosshead travel at break of the strap. Further, the present inventors believe that the geometric components having the S-shaped configuration increases strength of the embossed strap 1 in the rolling direction of the strap. Reduced elongation of the strap indicates improved bending stiffness of the strap.

In principle, at the same elongation, a thinner strap may have a lower break strength than a thicker strap. But that principle does not apply to the embossed strap 1 and embossed strap 2. As shown in Table 1, compared to the embossed strap 2, the embossed strap 1 has a lower thickness, a higher maximum strength at break, and a lower crosshead travel at break.

Further, using Finite Element Analysis (FEA) and mechanical properties of plastic straps, example plastic straps' response to tensile loading of the example straps was simulated. Dassault Systemes' Abaqus® v2019 was used for the FEA described herein. The material parameters used for the FEA described herein was elastic/plastic PP with “ductile damage evolution.” Further, the loading conditions used for the FEA described herein was loaded axially to a speed of 750 mm/s in 0.2 seconds. The straps modeled in FEA described herein have a raised pattern on one side of the strap.

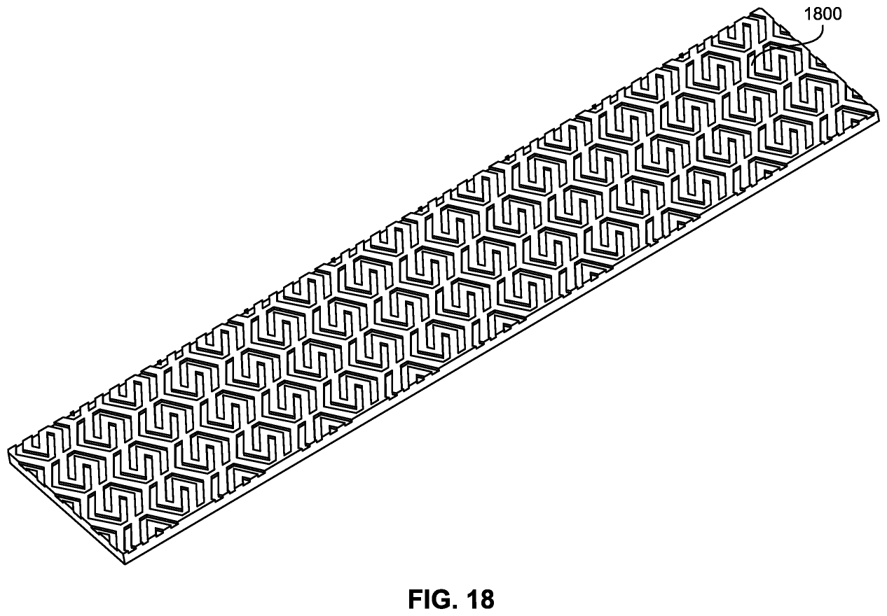

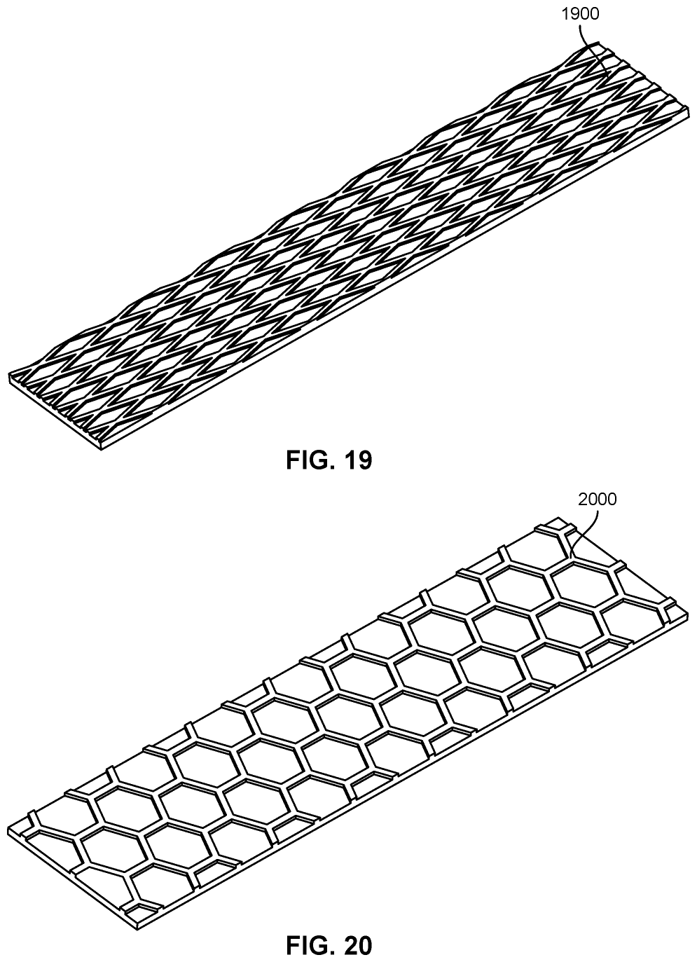

FIG. 18 illustrates a perspective view of an embossed strap 1800 modeled in FEA. The embossed strap 1800 has a raised pattern similar in form to the embossed strap 1600. Further, FIG. 19 illustrates a perspective view of another embossed strap 1900 modeled in FEA. The embossed strap 1900 has a raised pattern similar in form to the embossed strap 1700. The results of the FEA for the embossed strap 1800 and embossed strap 1900 are as follows:

TABLE 2

| | Width | Thickness | Length | Deboss | Vol. | Strength | Elongation | Stiffness |
|---|---|---|---|---|---|---|---|---|
| Strap | (mm) | (mm) | (mm) | (mm) | (mm²) | (N) | (mm) | (N/mm) |
| 1800 | 9.06 | 0.5 | 35 | 0.076 | 147.41 | 1519.00 | 5.23 | 610.90 |
| 1900 | 9.06 | 0.5 | 35 | 0.076 | 143.65 | 1502.78 | 5.29 | 602.90 |

The results of the FEA for the embossed strap 1800 and embossed strap 1900 are consistent with the data for embossed strap 1 and embossed strap 2. As shown in Table 2, compared with the embossed strap 1900, the embossed strap 1800 has a higher strength and lower elongation.

Without intending to be bound by theory, the present inventors believe that a raised pattern of a strap including a perimeter component and a geometric component positioned within the perimeter component provides improved strength and reduced elongation of the strap. In this regard, the present inventors believe that the perimeter component reduces elongation of the embossed strap. Further, the present inventors believe that the geometric component inhibits breaking of the embossed strap in the tensile direction.

Using FEA, the response to tensile loading of additional example plastic straps was simulated. FIGS. 20-22 illustrate perspective views of straps modeled in FEA. FIG. 20 illustrates a perspective view of an embossed strap 2000. The raised pattern of strap 2000 includes a hexagonal tessellation similar to the hexagonal tessellation of embossed strap 1900. However, embossed strap 2000 does not include a geometric component within the hexagonal cells.

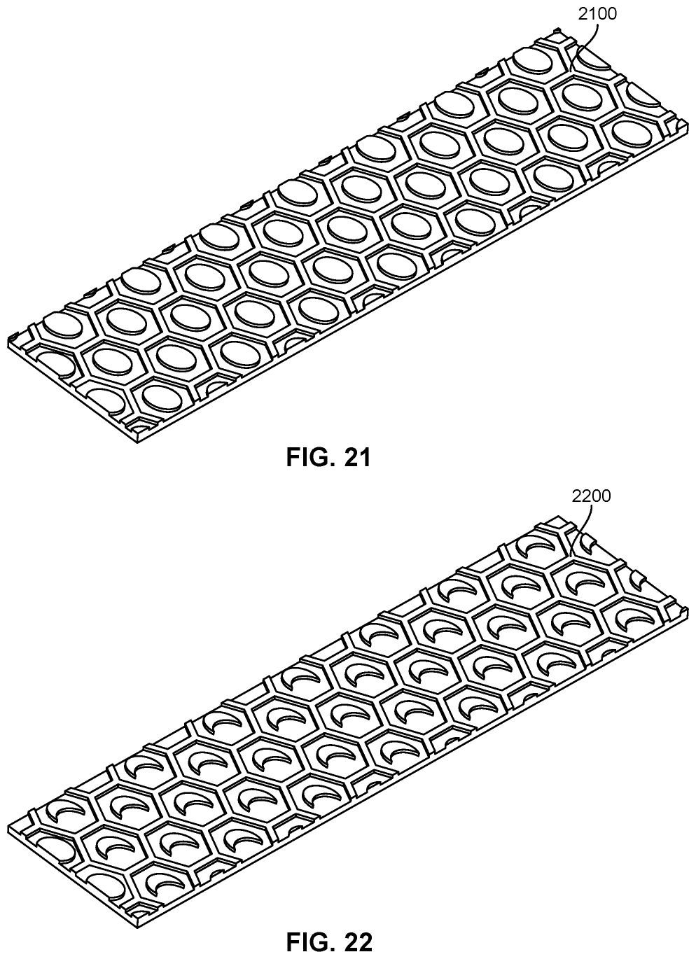

FIG. 21 illustrates a perspective view of an embossed strap 2100. The raised pattern of strap 2100 includes a hexagonal tessellation similar to the hexagonal tessellation of embossed strap 1800. Likewise, the raised pattern of strap 2100 also includes a geometric component within each of the cells formed by the hexagonal tessellation. However, the geometric component included in the raised pattern of strap 2100 has a circular shape and does not intersect the respective perimeter component formed by the hexagonal tessellation.

FIG. 22 illustrates a perspective view of an embossed strap 2200. The raised pattern of strap 2200 includes a hexagonal tessellation similar to the hexagonal tessellation of embossed strap 1800. Further, the raised pattern of strap 2200 includes a geometric component within each of the cells. However, the geometric component of the raised pattern of strap 2200 has a crescent moon shape that does not intersect the respective perimeter component formed by the hexagonal tessellation. The results of the FEA for the embossed strap 2000, embossed strap 2100, and embossed strap 2200 are as follows:

TABLE 3

| | Width | Thickness | Length | Deboss | Vol. | Strength | Elongation | Stiffness |
|---|---|---|---|---|---|---|---|---|
| Strap | (mm) | (mm) | (mm) | (mm) | (mm²) | (N) | (mm) | (N/mm) |
| 2000 | 9.06 | 0.5 | 35 | 0.076 | 139.03 | 1491.80 | 5.23 | 596.15 |
| 2100 | 9.06 | 0.5 | 35 | 0.076 | 172.00 | 1526.80 | 4.80 | 623.01 |
| 2200 | 9.06 | 0.5 | 35 | 0.076 | 143.62 | 1511.91 | 5.17 | 607.84 |

The results of the FEA for the embossed strap 2000, embossed strap 2100, and embossed strap 2200 are consistent with the results of the FEA for the embossed strap 1800 and embossed strap 1900. As shown in Table 3, compared with embossed strap 2000, each of the embossed strap 2100 and embossed strap 2200 have a higher strength and lower elongation.

FEA modeling showed that straps with a raised pattern having a perimeter component and a geometric shape positioned within the perimeter component (e.g., embossed straps 1800, 2100, and 2200) have a higher strength and lower elongation than straps with a raised pattern having a perimeter component but not including a geometric shape positioned within the perimeter component (e.g., embossed straps 1900 and 2000).

### III. CONCLUSION

Thus, in various embodiments, the present disclosure provides a plastic strap. The plastic strap includes a first side extending across a width of the strap, a second side opposite the first side and extending across the width of the strap, and a thickness extending between the first and second sides. The first side is embossed and includes a base surface and a raised pattern extending from the base surface. The raised pattern defines multiple cells. A first one of the cells is defined by a first perimeter component of the raised pattern and a first geometric component positioned within the first perimeter component so part of the base surface extends between the first perimeter component and the first geometric component.

In various such embodiments of the strap, the first perimeter component surrounds the first geometric component.

In various such embodiments of the strap, a second one of the cells is defined by a second perimeter component of the raised pattern, the first and second cells are adjacent, and a segment of the raised pattern is shared by the first perimeter component and the second perimeter component.

In various such embodiments of the strap, the raised pattern includes a tessellation, and the first perimeter component is part of the tessellation.

In various such embodiments of the strap, the shape of the first geometric component is unique from the shape of any portion of the tessellation.

In various such embodiments of the strap, the first perimeter component is hexagonal.

In various such embodiments of the strap, the part of the base surface that extends between the first perimeter component and the first geometric component surrounds the first geometric component.

In various such embodiments of the strap, the first geometric component intersects the first perimeter component.

In various such embodiments of the strap, the first geometric component is a non-linear path.

In various such embodiments of the strap, ends of the non-linear path intersect the first perimeter component.

In various such embodiments of the strap, the shape of each of the cells is the same.

In various such embodiments of the strap, a geometric component is included in each of a group of the cells.

In various such embodiments of the strap, a geometric component is included in each of the cells.

In various such embodiments of the strap, the strap comprises polypropylene.

In various such embodiments of the strap, the strap has a width in a range from 5 mm to 25 mm.

In various such embodiments of the strap, the strap has a thickness in a range from 0.40 mm to 0.60 mm.

In various such embodiments of the strap, the strap is coiled in a roll.

In various such embodiments of the strap, the second side is embossed.

In various other embodiments, the disclosure further provides a method of forming a strap. The method comprises extruding a polymer material to form a strap comprising a first side extending across a width of the strap, and a second side opposite the first side and extending across the width of the strap, and a thickness extending between the first and second sides. The first side of the strap is embossed to form a base surface and a raised pattern extending from the base surface. The raised pattern defines multiple cells. A first one of the cells is defined by a first perimeter component of the raised pattern and a first geometric component positioned within the first perimeter component so part of the base surface extends between the first perimeter component and the first geometric component.

Various changes and modifications to the above-described embodiments described herein will be apparent to those skilled in the art. These changes and modifications can be made without departing from the spirit and scope of this present subject matter and without diminishing its intended advantages. Not all of the depicted components described in this disclosure may be required, and some implementations may include additional, different, or fewer components from those expressly described in this disclosure. Variations in the arrangement and type of the components; the shapes, sizes, and materials of the components; and the manners of attachment and connections of the components may be made without departing from the spirit or scope of the claims as set forth herein. Also, unless otherwise indicated, any directions referred to herein reflect the orientations of the components shown in the corresponding drawings and do not limit the scope of the present disclosure. This specification is intended to be taken as a whole and interpreted in accordance with the principles of the invention as taught herein and understood by one of ordinary skill in the art.

1. A plastic strap comprising:
a first side extending across a width of the strap;
a second side opposite the first side and extending across the width of the strap; and
a thickness extending between the first and second sides,
wherein the first side is embossed and includes a base surface and a raised pattern extending from the base surface,
wherein the raised pattern defines multiple cells, and
wherein a first one of the cells is defined by a first perimeter component of the raised pattern and a first geometric component of the raised pattern positioned within the first perimeter component so part of the base surface extends between the first perimeter component and the first geometric component.

2. The plastic strap of claim 1, wherein the first perimeter component surrounds the first geometric component.

3. The plastic strap of claim 1, wherein a second one of the cells is defined by a second perimeter component of the raised pattern, wherein the first and second cells are adjacent, and wherein a segment of the raised pattern is shared by the first perimeter component and the second perimeter component.

4. The plastic strap of claim 1, wherein the raised pattern includes a tessellation, and wherein the first perimeter component is part of the tessellation.

5. The plastic strap of claim 4, wherein the shape of the first geometric component is unique from the shape of any portion of the tessellation.

6. The plastic strap of claim 1, wherein the first perimeter component is hexagonal.

7. The plastic strap of claim 1, wherein the part of the base surface that extends between the first perimeter component and the first geometric component surrounds the first geometric component.

8. The plastic strap of claim 1, wherein the first geometric component intersects the first perimeter component.

9. The plastic strap of claim 1, wherein the first geometric component is a non-linear path.

10. The plastic strap of claim 9, wherein ends of the non-linear path intersect the first perimeter component.

11. The plastic strap of claim 1, wherein the shape of each of the cells is the same.

12. The plastic strap of claim 1, wherein a geometric component is included in each of a group of the cells.

13. The plastic strap of claim 1, wherein a geometric component is included in each of the cells.

14. The plastic strap of claim 1, wherein the strap comprises polypropylene.

15. The plastic strap claim 1, wherein the strap has a width in a range from 2 mm to 25 mm.

16. The plastic strap of claim 1, wherein the strap has a thickness in a range from 0.40 mm to 0.60 mm.

17. The plastic strap of claim 1, wherein the strap is coiled in a roll.

18. The plastic strap of claim 1, wherein the second side is embossed.

19. A method of forming a plastic strap comprising:
extruding a polymer material to form a strap comprising a first side extending across a width of the strap, and a second side opposite the first side and extending across the width of the strap, and a thickness extending between the first and second sides; and
embossing the first side of the strap to form a base surface and a raised pattern extending from the base surface,
wherein the raised pattern defines multiple cells, and
wherein a first one of the cells is defined by a first perimeter component of the raised pattern and a first geometric component of the raised pattern positioned within the first perimeter component so part of the base surface extends between the first perimeter component and the first geometric component.

20. The method of claim 19, wherein the first perimeter component surrounds the first geometric component.
